(19) United States
(12) Patent Application Publication
(10) Pub. No.: US 2025/0078099 A1
(43) Pub. Date: Mar. 6, 2025

(54) METHODS AND SYSTEMS FOR GENERATING SCALABLE TASK-AGNOSTIC EMBEDDINGS FOR TRANSACTION DATA

(71) Applicant: MASTERCARD INTERNATIONAL INCORPORATED, Purchase, NY (US)

(72) Inventors: Govind Vitthal WAGHMARE, Pune (IN); Ankur ARORA, New Delhi (IN); Ankur DEBNATH, Bongaigaon (IN); Sachin ., Alwar (IN); Siddhartha ASTHANA, New Delhi (IN)

(73) Assignee: MASTERCARD INTERNATIONAL INCORPORATED, Purchase, NY (US)

(21) Appl. No.: 18/819,864

(22) Filed: Aug. 29, 2024

(30) Foreign Application Priority Data
Aug. 30, 2023 (IN) 202341058265

(51) Int. Cl. G06Q 30/0201; G06N 3/0442

(52) U.S. Cl. CPC G06Q 30/0201; G06N 3/0442

(57) ABSTRACT

Embodiments provide artificial intelligence-based methods and systems for generating scalable task-agnostic embeddings for training task-specific models. Method performed by server system includes accessing historical transaction data from database. Historical transaction data includes entity-specific data, cardholder-specific data, and transaction-specific data. Method includes generating one or more pseudo-objective models for each of plurality of entities based on historical transaction data and one or more pseudo-objectives. Plurality of entities includes acquirer, merchant, and issuer. Method includes determining via one or more pseudo-objective models, entity-specific embeddings for each entity of plurality of entities based on entity-specific data. Entity-specific embeddings includes acquirer-specific embeddings, merchant-specific embeddings, and issuer-specific embeddings. Upon receiving request to induct new entity, method includes accessing new entity data associated with new entity from database. Method includes determining approximate embeddings corresponding to new entity based on new entity data and entity-specific embeddings and updating one of entity-specific embeddings based on approximate embeddings.

### TECHNICAL FIELD

The present disclosure relates to artificial intelligence-based processing systems in payment ecosystems and, more particularly to generating scalable embeddings for transaction data associated with various entities (such as issuers, acquirers, cardholders, and merchants) engaged in transactions within a payment ecosystem.

### BACKGROUND

In recent years, the increasing availability of Artificial Intelligence (AI) and Machine Learning (ML) techniques and algorithms has resulted in their widespread adoption across various industries. In the financial sector, for instance, AI and ML models are used to perform various tasks such as data processing, fraud detection, customer behavior analysis, and the like. It is understood that within the financial sector, issuing banks (commonly known as issuers) provide payment instruments such as credit and debit cards to account holders or cardholders. These cardholders may conduct transactions at merchants with financial accounts operated by acquiring banks (commonly known as acquirers). These transactions are usually facilitated by payment processors such as Mastercard®. At scale, where millions of transactions are performed every day, transaction-related data (known as transaction data) can be leveraged by AI or ML models to perform the various tasks described earlier. The transaction data includes information or attributes related to different transactions and different entities involved in the transaction process such as cardholders, merchants, issuers, and acquirers. However, before an AI or ML model can perform any specific task, it must first undergo training and testing on relevant transaction data before it can be deployed in operation.

Conventionally, for training these AI or ML models, historical transaction data is divided into training data and testing data. Thereafter, the model is trained on the training data and tested on the testing data. Further, the model's operating parameters can be adjusted to improve the model's performance. More specifically, training data is used to generate task-specific features/representations which are further used to generate weights of the various layers within the model. The weights can be back-propagated to refine the model till the model performance saturates. For example, an ML-based fraud detection model for predicting whether a future transaction at a merchant by a particular cardholder will be disputed as fraud or not can be trained on a portion of the historical transaction data and later on be tested on the subsequent portion of the historical transaction data.

However, such AI or ML models are limited in their ability to learn the distinct relationships between the different entities present in the payment ecosystem. This limitation arises from a lack of entity-level semantics, which prevents the model from understanding the explicit interactions between different entities. In particular, a lack of independent representation of the attributes of different entities, a lack of understanding of the explicit interactions between the dynamic entities and the static entities, and a lack of differentiation between the static and dynamic attributes within transaction data leads to this limitation. Herein, the term “static attributes” refers to attributes or information related to the static entities within the payment network, i.e., the cardholders and the issuers. Further, the term “dynamic attributes” refers to attributes or information related to the dynamic entities within the payment network, i.e., the merchants and the acquirers. Furthermore, the inherent structure of transaction data, which does not differentiate between static and dynamic attributes, makes it challenging for models to learn the unique relationships between different entities. To that end, when a task-specific AI or ML model is trained on the transaction data, it is unable to learn the distinct relationships shared between different acquirers and merchants. Moreover, when new entities are introduced into the payment network, the conventionally trained AI or ML models have to be retrained from scratch, leading to a cold start problem. This results in increased consumption of processing resources, longer timelines for model training, and delays in model redeployment.

Hence, there exists a technological need for more efficient methods and systems that can address the above-mentioned technical problems and provide a task-agnostic and scalable technique for training AI or ML models for improving the efficiency of training/generating task-specific models, reduce the consumption of processing resources, and speed up model redeployment when new entities are inducted in the payment network.

### SUMMARY

Various embodiments of the present disclosure provide methods and systems for generating scalable task-agnostic embeddings for training or learning task-specific Artificial Intelligence (AI) or Machine Learning (ML) models.

In an embodiment, a computer-implemented method for generating scalable task-agnostic embeddings for training or learning task-specific AI or ML models is disclosed. The computer-implemented method performed by a server system includes accessing historical transaction data from a database associated with the server system. Herein, the historical transaction data includes entity-specific data, cardholder-specific data, and transaction-specific data. Further, the method includes generating one or more pseudo-objective models for each of a plurality of entities based, at least in part, on the historical transaction data and one or more pseudo-objectives. Herein, the plurality of entities includes an acquirer, a merchant, and an issuer. Further, the method includes determining via the one or more pseudo-objective models, entity-specific embeddings for each entity of the plurality of entities based, at least in part, on the entity-specific data. Herein, the entity-specific embeddings include acquirer-specific embeddings, merchant-specific embeddings, and issuer-specific embeddings. Upon receiving a request to induct a new entity, the method further includes accessing new entity data associated with the new entity from the database. Herein, the new entity data includes transaction data associated with the new entity. Further, the method includes determining approximate embeddings corresponding to the new entity based, at least in part, on the new entity data and the entity-specific embeddings. Further, the method includes updating one of the entity-specific embeddings based, at least in part, on the approximate embeddings.

In another embodiment, a server system is disclosed. The server system includes a communication interface and a memory including executable instructions. The server system also includes a processor communicably coupled to the memory. The processor is configured to execute the instructions to cause the server system, at least in part, to access historical transaction data from a database associated with the server system. Herein, the historical transaction data includes entity-specific data, cardholder-specific data, and transaction-specific data. Further, the server system is caused to generate one or more pseudo-objective models for each of a plurality of entities based, at least in part, on the historical transaction data and one or more pseudo-objectives. Herein, the plurality of entities includes an acquirer, a merchant, and an issuer. Further, the server system is caused to determine via the one or more pseudo-objective models, entity-specific embeddings for each entity of the plurality of entities based, at least in part, on the entity-specific data. Herein, the entity-specific embeddings include acquirer-specific embeddings, merchant-specific embeddings, and issuer-specific embeddings. Upon receiving a request to induct a new entity, the server system is further configured to access new entity data associated with the new entity from the database. Herein, the new entity data includes transaction data associated with the new entity. Further, the server system is configured to determine approximate embeddings corresponding to the new entity based, at least in part, on the new entity data and the entity-specific embeddings. Further, the server system is configured to update one of the entity-specific embeddings based, at least in part, on the approximate embeddings.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing historical transaction data from a database associated with the server system. Herein, the historical transaction data includes entity-specific data, cardholder-specific data, and transaction-specific data. Further, the method includes generating one or more pseudo-objective models for each of a plurality of entities based, at least in part, on the historical transaction data and one or more pseudo-objectives. Herein, the plurality of entities includes an acquirer, a merchant, and an issuer. Further, the method includes determining via the one or more pseudo-objective models, entity-specific embeddings for each entity of the plurality of entities based, at least in part, on the entity-specific data. Herein, the entity-specific embeddings include acquirer-specific embeddings, merchant-specific embeddings, and issuer-specific embeddings. Upon receiving a request to induct a new entity, the method further includes accessing new entity data associated with the new entity from the database. Herein, the new entity data includes transaction data associated with the new entity. Further, the method includes determining approximate embeddings corresponding to the new entity based, at least in part, on the new entity data and the entity-specific embeddings. Further, the method includes updating one of the entity-specific embeddings based, at least in part, on the approximate embeddings.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present technology, reference is now made to the following descriptions taken in connection with the accompanying drawings in which.

FIG. 1 illustrates an exemplary representation of an environment related to at least some embodiments of the present disclosure;

FIG. 2 is a simplified block diagram of a server system, in accordance with an embodiment of the present disclosure;

FIG. 3A illustrates a block diagram of a first pseudo-objective model for predicting a monthly Gross domestic value (GDV) for a certain time period, in accordance with an embodiment of the present disclosure;

FIG. 3B illustrates a block diagram of a second pseudo-objective model for predicting an industry-level classification of a merchant, in accordance with an embodiment of the present disclosure;

FIG. 4 illustrates a simplified block diagram for generating a task-specific model from task-agnostic embeddings learned from a plurality of entities within a payment network, in accordance with an embodiment of the present disclosure;

FIG. 5 illustrates a simplified block diagram for aggregating dynamic embeddings via a geometric decay network, in accordance with an embodiment of the present disclosure;

FIG. 6 illustrates a method for updating the entity-specific embeddings when a new entity is inducted into the payment network, in accordance with an embodiment of the present disclosure;

FIG. 7 illustrates a method for generating (or training) a task-specific model, in accordance with an embodiment of the present disclosure;

FIG. 8 illustrates a simplified block diagram of a payment server, in accordance with an embodiment of the present disclosure;

FIG. 9 illustrates a simplified block diagram of an acquirer server, in accordance with an embodiment of the present disclosure; and

FIG. 10 illustrates a simplified block diagram of an issuer server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, system, method, or computer program product. Accordingly, embodiments of the present disclosure may take the form of an entirely hardware embodiment, an entirely software embodiment (including firmware, resident software, micro-code, etc.), or an embodiment combining software and hardware aspects that may all generally be referred to herein as a “circuit,” “engine” “module” or “system.” Furthermore, aspects of the present disclosure may take the form of a computer program product embodied in one or more computer-readable storage media having computer-readable program code embodied thereon.

The term “payment account” used throughout the description refers to a financial account that is used to fund a financial transaction (interchangeably referred to as “card-on-file payment transaction”). Examples of financial accounts include but are not limited to, a savings account, a credit account, a checking account, and a virtual payment account. The financial account may be associated with an entity (known as an account holder) such as an individual person, a family, a commercial entity, a company, a corporation, a governmental entity, a non-profit organization, and the like. In some scenarios, a financial account may be a virtual or a temporary payment account that can be mapped or linked to a primary financial account, such as those accounts managed by payment wallet service providers, and the like.

The term “account holder” used throughout the description refers to an owner of the payment account. Examples of the account holder include a customer of the issuing bank that has either a savings account, a credit account, a checking account, or a virtual payment account with the issuing bank. In some scenarios, the account holder may be issued a payment card (such as a credit card, a debit card, or the like.) by the issuing bank. Upon being issued the payment card, the account holder can also be called a cardholder. To that end, the term “cardholder” is used throughout the description, and refers to a person (i.e., the account holder) who holds a credit or a debit card that will be used by a merchant to perform a card-on-file payment transaction. It should be noted that the terms “account holder” and “cardholder” are used interchangeably throughout the description for the purposes of explanation however, the account holder doesn't necessarily have to be a cardholder and vice-versa.

The term “payment network”, used herein, refers to a network or a collection of systems used for the transfer of funds through the use of cash substitutes. Payment networks may use a variety of different protocols and procedures in order to process the transfer of money for various types of transactions. Transactions that may be performed via a payment network may include goods or service purchases, credit purchases, debit transactions, fund transfers, account withdrawals, etc. Payment networks may be configured to perform transactions via cash substitutes, which may include payment cards, letters of credit, checks, financial accounts, etc. Examples of networks or systems configured to perform as payment networks include those operated by such as Mastercard®.

The term “merchant”, used throughout the description generally refers to a seller, a retailer, a purchase location, an organization, or any other entity that is in the business of selling goods or providing services, and it can refer to either a single business location or a chain of business locations of the same entity.

### Overview

Various embodiments of the present disclosure provide methods, systems, user devices, and computer program products for generating scalable task-agnostic embeddings for training or learning task-specific Artificial Intelligence (AI) or Machine Learning (ML) models. In some scenarios, the various embodiments of the present disclosure may be implemented by a server system. In an example, the server system is a payment server associated with a payment network.

In an embodiment, the server system is configured to access historical transaction data from a database associated with the server system. In various non-limiting examples, the historical transaction data includes entity-specific data, cardholder-specific data, and transaction-specific data. In another embodiment, the server system is configured to generate one or more pseudo-objective models for each of a plurality of entities based, at least in part, on the historical transaction data and one or more pseudo-objectives. Herein, the plurality of entities includes an acquirer, a merchant, and an issuer. In an example, the one or more pseudo-objectives are determined for a task to be performed by the one or more pseudo-objective models based, at least in part, on a set of predefined rules. In an example, for generating the one or more pseudo-objective models for each of the plurality of entities, the server system at first is configured to determine an entity category of each of the plurality of entities based, at least in part, on the historical transaction data. Then, the server system is configured to determine a desired model type for each of the one or more pseudo-objective models based, at least in part, on the entity category and each of the one or more pseudo-objectives. Finally, the sever system is configured to generate the one or more pseudo-objective models for each of the plurality of entities based, at least in part, on the desired model type and the historical transaction data.

In another embodiment, the server system is configured to determine via the one or more pseudo-objective models, entity-specific embeddings for each entity of the plurality of entities based, at least in part, on the entity-specific data. Herein, the entity-specific embeddings include acquirer-specific embeddings, merchant-specific embeddings, and issuer-specific embeddings.

In another embodiment, upon receiving a request to induct a new entity, the server system is configured to access new entity data associated with the new entity from the database. Herein, the new entity data includes transaction data associated with the new entity. In another embodiment, the server system is configured to determine approximate embeddings corresponding to the new entity based, at least in part, on the new entity data and the entity-specific embeddings. In an implementation, determining the approximate embeddings corresponding to the new entity includes at first determining a new entity category of the new entity based, at least in part, on the new entity data. Herein, the new entity category is one of a new acquirer, a new merchant, and a new issuer. Then, determining a geo-location of the new entity based, at least in part, on the new entity data. Thereafter, determining one or more neighboring entities with an identical entity category to the new entity category from the plurality of entities based, at least in part, on the transaction-specific data. Further, extracting one or more entity-specific embeddings associated with the one or more neighboring entities from the entity-specific embeddings of each of the plurality of entities. Furthermore, computing an average of the one or more entity-specific embeddings associated with the one or more neighboring entities to determine the approximate embeddings corresponding to the new entity. In another embodiment, the server system is configured to update one of the entity-specific embeddings based, at least in part, on the approximate embeddings.

In another embodiment, the server system is configured to generate via a dynamic entity model, dynamic embeddings corresponding to each of a plurality of transactions based, at least in part, on the acquirer-specific embeddings, the merchant-specific embeddings, and the transaction-specific data.

In another embodiment, the server system is configured to generate aggregated dynamic embeddings corresponding to a plurality of transactions based, at least in part, on aggregating each of the dynamic embeddings corresponding to each of the plurality of transactions. In one scenario, aggregating each of the dynamic embeddings corresponding to each of a plurality of transactions is performed via at least one of a recurrent neural network (RNN) and a long short-term memory network (LSTM) model. In another scenario, aggregating each of the dynamic embeddings corresponding to each of a plurality of transactions is performed via a geometric decay network. In this scenario, at first, the server system is configured to compute via the geometric decay network, a weighted sum of the dynamic embeddings corresponding to each of the plurality of transactions to generate the aggregated dynamic embeddings based, at least in part, on a geometric decay factor.

In another embodiment, the server system is configured to generate via a static entity model, static embeddings based, at least in part, on the issuer-specific embeddings and the cardholder-specific data. In another embodiment, the server system is configured to generate a task-specific model based, at least in part, on the aggregated dynamic embeddings and the static embeddings.

Various embodiments of the present disclosure provide multiple advantages and technical effects while addressing technical problems such as how to improve model performance when learning from a plurality of entities, how to generate a scalable model, how to solve the cold start problem, and the like. To that end, the various embodiments of the present disclosure provide an approach for generating scalable task-agnostic embeddings for training or learning task-specific AI or ML models. It is noted that the use of the embeddings as described herein, is preferred over features due to advantages such as the ability of the embeddings for capturing non-linear relationships, dimension reduction, performance improvement, transferability, and the like. As may be understood, entity-specific embeddings allow the model to learn the behavior of each entity in the payment network first and then understand how they interact with other entities. In other words, by segregating the dynamic attributes associated with the dynamic entities from the static attributes associated with the static entities, the noise generated while the models operate to generate the embeddings (i.e., the aggregated dynamic embeddings and the static embeddings) is reduced.

Further, the use of aggregated dynamic embeddings and static embeddings improves the performance of task-specific models. It is noted that this decoupling preserves the relationship between different entities while improving the understanding of the model towards the individual entities. Additionally, since the entity-specific embeddings can be updated without retraining the model using the approach described herein, the cold start problem is also addressed. Therefore, saving processing resources, and time thus, preventing delays that may be caused due to retraining of models. Furthermore, as may be understood, since the RNN, the LSTM, and the geometric decay network are scalable in nature, therefore the dynamic entity model is also scalable in nature.

To that end, various embodiments of the present disclosure provide methods, systems, user devices, and computer program products for generating scalable task-agnostic embeddings for training or learning task-specific Artificial Intelligence (AI) or Machine Learning (ML) models.

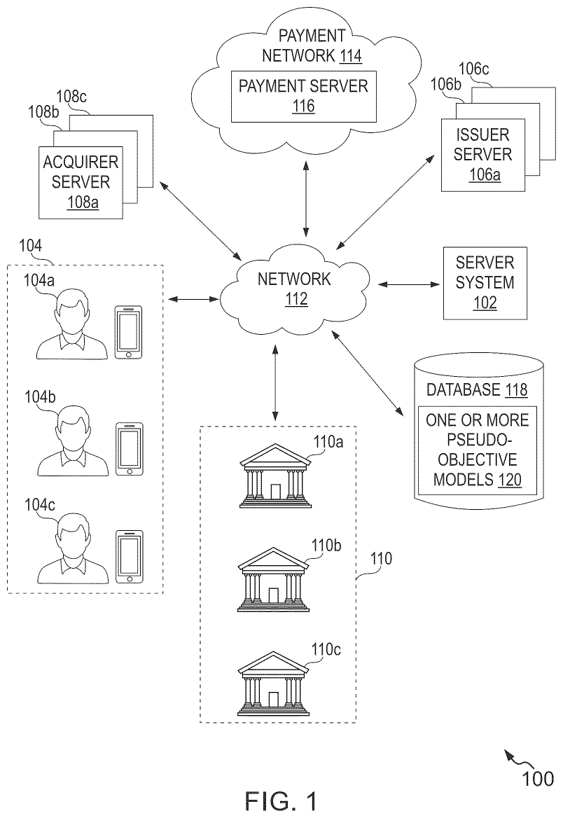

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, generating task-agnostic embeddings from transaction data, updating the task-agnostic embeddings when a new entity is inducted in the payment network 114, training task-specific AI or ML models based on the task-agnostic embeddings, etc. The environment 100 generally includes a plurality of entities, for example, a server system 102, a plurality of cardholders 104 (including a cardholder 104a, a cardholder 104b, and a cardholder 104c) associated with a plurality of electronic devices, a plurality of issuer servers 106 (including an issuer server 106a, an issuer server 106b, and an issuer server 106c), a plurality of acquirer servers 108 (including an acquirer server 108a, an acquirer server 108b, and an acquirer server 108c), a plurality of merchants 110 (including a merchant 110a, a merchant 110b, and a merchant 110c), the payment network 114 including a payment server 116, a database 118, each coupled to, and in communication with (and/or with access to) a network 112. The network 112 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among the entities illustrated in FIG. 1, or any combination thereof.

It is noted that the phrases “plurality of cardholders 104”, “plurality of issuer servers 106”, “plurality of acquirer servers 108”, and “plurality of merchants 110” hereinafter are collectively referred to as “cardholders 104”, “issuer server 106”, “acquirer server 108”, and “merchants 110” respectively for ease of description.

Various entities in the environment 100 may connect to the network 112 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. For example, the network 112 may include multiple different networks, such as a private network made accessible by the payment network 114 to the issuer server 106, the acquirer server 108, and the payment server 116, separately, and a public network (e.g., the Internet, etc.).

In an embodiment, the issuer server 106 (such as the issuer server 106a) refers to a computing server that is associated with an issuer bank of the cardholders 104. The issuer bank is a financial institution that manages the accounts of multiple account holders. Account details of the accounts established with the issuer bank are stored in the cardholder profiles of the account holder in a memory of the issuer server 106 or on a cloud server associated with the issuer server 106. The issuer server 106 is responsible for approving or denying any request for the movement of funds associated with a payment transaction. For instance, the issuer server 106 may approve or decline a payment authorization request. The terms “issuer”, “issuer bank”, “issuing bank” or “issuer server” are used interchangeably herein for the sake of description. It is noted that within the payment network 114, the issuer server 106 and the cardholders 104 constitute static entities since the attributes or information related to these entities remain static within the payment network 114 for different payment transactions over a period of time.

In an embodiment, the acquirer server 108 (such as the acquirer server 108a) is a computing server that is associated with an acquirer bank of any merchant such as the merchants 110. The acquirer bank is a financial institution (e.g., a bank) that processes financial transactions. This can be an institution that facilitates the processing of payment transactions for physical stores, ATM terminals, merchants, or an institution that owns platforms that make online purchases or purchases made via software applications possible (e.g., shopping cart platform providers and in-app payment processing providers). The terms “acquirer”, “acquirer bank”, “acquiring bank” or “acquirer server” will be used interchangeably herein for the sake of description. It is noted that within the payment network 114, the acquirer server 108 and the merchants 110 constitute dynamic entities since the attributes or information related to these entities are dynamic within the payment network 114 for different payment transactions performed by a particular payment card over a period of time. For instance, a merchant 110a will have different attributes or information when compared with another merchant 110b. Similarly, the acquirer servers associated with each of these merchants may be different for different transactions with the merchants by a cardholder 104a performed by a particular payment card as well. For instance, the merchant 110a can be associated with the acquirer server 108a and the merchant 110b can be associated with the acquirer server 108b. For example, when the transaction data related to a set of transactions performed by the cardholder 104a associated with the issuer server 106a with merchants 110a and 110b is considered. Then, although cardholder-specific attributes and issuer-specific attributes will remain the same, i.e., static for a particular payment card associated with the cardholder 104a, the acquirer-specific attributes and merchant-specific attributes will be different, i.e., dynamic.

In an embodiment, the payment server 116 is a computing server that is associated with a payment processing financial institution (e.g., Mastercard®) that facilitates the communication between the issuer 106 and the acquirer 108. Various messages and requests are exchanged between the issuer 106 and the acquirer 108 through the payment server 116. For example, the issuer 106 routes an authorization response message to the acquirer 108 via the payment network 114 through the payment server 116 to authorize or decline a payment transaction.

In one non-limiting example, the issuer server 106, the acquirer server 108, and the payment server 116 generally operate task-specific AI or ML models trained on historical payment transaction data to perform various tasks such as data processing, fraud detection, entity category classification, customer behavior analysis, and the like. For generating a task-specific AI or ML model, it first needs to be trained and tested. To achieve this, at first, transaction-related attributes included within the historical payment transaction data are used to generate task-specific features/representations which are further used to generate weights of various layers within the model. The weights can be back-propagated to refine the model till the model performance saturates. More specifically, transaction attributes from the various entities associated with a plurality of transactions are extracted. It is understood that generally, the attributes present within the historical payment transaction data can be broadly categorized as numerical attributes and categorical attributes. For example, the numerical attributes may include attributes such as transaction count, transaction amount, and the like while the categorical attributes may include attributes such as a cardholder type, a transaction status, and the like. The process of extracting these attributes is done based on the task for which the task-specific model has to be trained. In other words, the attribute extraction process is a task-specific process. Then, these extracted attributes are used to generate features/representations for generating the task-specific AI or ML model. The feature generation process generally includes steps such as feature selection and filtering, feature transformation, feature creation, and feature normalization (for numeric data). In an implementation, the numerical attributes can be directly converted to feature values by the feature generation process. In another implementation, the categorical attributes are converted to features using known encoding techniques such as One Hot encoding (OHE), entity encoding, and the like.

In a particular non-limiting implementation, embeddings can be used for representing the feature data (which are high dimensional vectors) into a lower dimension space. Generally, the use of the embeddings in the AI or ML models is preferred over features due to advantages such as the ability of the embeddings for capturing non-linear relationships, dimension reduction, performance improvement, transferability, and the like.

After the task-specific AI or ML model is generated, it undergoes training and testing using the historical payment transaction data. However, these models have limitations in learning the relationships between the different entities in a payment ecosystem, leading to poor model performance. This limitation arises due to a lack of entity-level semantics, which hinders the model from understanding explicit interactions between the entities. Specifically, a lack of independent representation of entity attributes, understanding of interactions between dynamic and static entities, and differentiation between static and dynamic attributes in the transaction data contribute to this limitation. The inherent structure of the transaction data, which does not differentiate between the static and dynamic attributes, further complicates the learning of unique relationships between the entities. As a result, the task-specific AI or ML models trained on the transaction data cannot learn the distinct relationships shared between different acquirers and merchants. Additionally, introducing new entities in the payment network 114 requires retraining conventionally trained models from scratch, resulting in a cold start problem, increased consumption of processing resources, longer timelines for model training, and delays in model redeployments.

To address the above-mentioned technical problem among other problems, the server system 102 is provided by the present disclosure that is configured to perform one or more of the operations described herein. In one non-limiting example, the server system 102 is embodied in the payment server 116. In some scenarios, the server system 102 is a separate part of the environment 100 and may operate apart from (but still in communication with, for example, via the network 112), the issuer server 106, the acquirer server 108, the payment server 116, and any third-party external servers (to access data to perform the various operations described herein). However, in other embodiments, the server system 102 may be incorporated, in whole or in part, into one or more parts of the environment 100, for example, the payment server 116. In addition, the server system 102 should be understood to be embodied in at least one computing device in communication with the network 112, which may be specifically configured, via executable instructions, to perform as described herein, and/or embodied in at least one non-transitory computer-readable media.

In an embodiment, the server system 102 is associated, i.e., communicably coupled with a database such as the database 118. In an embodiment, the database 118 is a central repository for storing data including the historical payment transaction data, the various machine learning models including one or more pseudo-objective models 120, a dynamic entity model, a static entity model, machine-readable instructions, and algorithms for operating the server system 102. In various implementations, the database 118 can be embodied within the server system 102, as a part of the server system 102, or as an independent entity that is communicably coupled with the server system 102 via the network 112.

In various non-limiting examples, the database 118 may include one or more hard disk drives (HDD), solid-state drives (SSD), an Advanced Technology Attachment (ATA) adapter, a Serial ATA (SATA) adapter, a Small Computer System Interface (SCSI) adapter, a redundant array of independent disks (RAID) controller, a storage area network (SAN) adapter, a network adapter, and/or any component providing the server system 102 with access to the database 118. In one implementation, the database 118 may be viewed, accessed, amended, updated, and/or deleted by an administrator (not shown) associated with the server system 102 through a database management system (DBMS) or relational database management system (RDBMS) present within the database 118.

In an embodiment, the server system 102 is configured to access the historical payment transaction data from a database such as the database 118 associated with the server system 102. In an instance, the transaction-related data stored within the historical payment transaction data can be classified into different categories such as entity-specific data, cardholder-specific data, and transaction-specific data. Herein, the entity-specific data can be further classified as acquirer-specific data, merchant-specific data, and issuer-specific data. As described earlier, the attributes associated with the issuer-specific data and the cardholder-specific data are known as static attributes while the attributes associated with the acquirer-specific data and the merchant-specific data are known as dynamic attributes. Further, the transaction-specific data correspond to those attributes which are not related or a part of the attributes associated with the issuer-specific data, the cardholder-specific data, the acquirer-specific data, and the merchant-specific data.

In another embodiment, the server system 102 is configured to generate one or more pseudo-objective models 120 for each of a plurality of entities (i.e., the issuer server 106, the acquirer server 108, and the merchants 110) based, at least in part, on the historical payment transaction data and one or more pseudo-objectives. It is understood that the one or more pseudo-objective models 120 are AI or ML-based models that are used to capture the generalized behavior of the plurality of entities within the payment network 114. In various non-limiting examples, the one or more pseudo-objectives may include at least one or more of a task for predicting a Gross domestic value (GDV), a task of transaction attribute classification, and the like. In some scenarios, the one or more pseudo-objectives may be predetermined based on one or more internal policies or defined by the administrator of the server system 102.

In another embodiment, the server system 102 is configured to determine via the one or more pseudo-objective models 120, entity-specific embeddings for each entity based, at least in part, on the entity-specific data. The entity-specific embeddings may further include acquirer-specific embeddings, merchant-specific embeddings, and issuer-specific embeddings. It is noted that entity-specific embeddings are generalized embeddings that indicate the general behavior of the entities while in isolation for transactions performed by each payment card of the plurality of payment cards (not shown) associated with the plurality of cardholders 104. In another example, the entity-specific embeddings are generalized embeddings that indicate the general behavior of the entities while in isolation for transactions performed by each account of the plurality of accounts (not shown) associated with the plurality of accountholders, i.e., cardholders 104. In other words, acquirer-specific embeddings, merchant-specific embeddings, and issuer-specific embeddings indicate the feature representations of the entity that are learned in isolation. This aspect controls the number of interactions within and across entities in the payment network 114. For instance, the merchant-specific embeddings are learned from the understanding of the merchant such as the merchant 110b first before learning about the interaction between merchant and issuer. In other words, entity-specific embeddings allow the server system 102 to learn the behavior of an entity (such as the merchant 110b) first and then understand how they interact with other entities. This is called abstraction at the entity level. It is noted that in the context of the transaction data, i.e., temporal in nature, abstraction is enforced by logical entity-driven transaction structure.

In another embodiment, the server system 102 is configured to generate via the dynamic entity model, dynamic embeddings corresponding to each of a plurality of transactions performed between the cardholders 104 and merchants 110 based, at least in part, on the acquirer-specific embeddings, the merchant-specific embeddings, and the transaction-specific data. Further, the server system 102 is configured to generate aggregated dynamic embeddings corresponding to a plurality of transactions based, at least in part, on aggregating each of the dynamic embeddings corresponding to each of the plurality of transactions. As may be understood, the dynamic embeddings allow the server system 102 to learn how the dynamic entities, i.e., the merchant and the acquirer interact with each other. In other words, the dynamic embeddings are learned on the hierarchical interactions across different entities.

Further, the server system 102 is configured to generate via the static entity model, static embeddings based, at least in part, on the issuer-specific embeddings, and the cardholder-specific data. The static embeddings allow the server system 102 to learn how the static entities, i.e., the cardholder and the issuer interact with each other. In other words, the static embeddings are learned on the hierarchical interactions across different entities as well. Further, any task-specific machine learning model can be generated based, at least in part, on the aggregated dynamic embeddings and the static embeddings. Since the aggregated dynamic embeddings and the static embeddings are based on entity-specific embeddings, they are also task-agnostic, therefore they can be directly used to generate and train task-specific models. Further, the use of aggregated dynamic embeddings and static embeddings by the server system 102 improves the performance of the task-specific models. It is noted that segregating the dynamic attributes associated with the dynamic entities from the static attributes associated with the static entities reduces the noise generated while the models operate. Further, this decoupling preserves the relationship between different entities while improving the understanding of the model of individual entities.

Furthermore, the server system 102 is configured to receive a request to induct a new entity and upon receiving the induction request, the server system 102 is further configured to access new entity data associated with the new entity from the database 118. In a non-limiting example, the new entity data includes transaction data associated with the new entity. Then, the server system 102 is configured to determine or generate approximate embeddings corresponding to the new entity based, at least in part, on the new entity data and the entity-specific embeddings. Thereafter, the server system 102 is configured to update one of the entity-specific embeddings based, at least in part, on the approximate embeddings. This aspect is described further in detail later in the present disclosure. It is understood that since the entity-specific embeddings are task-agnostic in nature, they can be updated using the approximate embeddings. Since the entity-specific embeddings can be updated without retraining the model, the cold start problem is addressed thereby, saving processing resources, and time thus preventing delays while deploying models.

In one embodiment, the payment network 114 may be used by the payment card issuing authorities as a payment interchange network. The payment network 114 may include a plurality of payment servers such as the payment server 116. Examples of payment interchange networks include but are not limited to, Mastercard® payment system interchange network. The Mastercard® payment system interchange network is a proprietary communications standard promulgated by Mastercard International Incorporated® for the exchange of financial transactions among a plurality of financial activities that are members of Mastercard International Incorporated®. (Mastercard is a registered trademark of Mastercard International Incorporated located in Purchase, N.Y.).

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device as shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

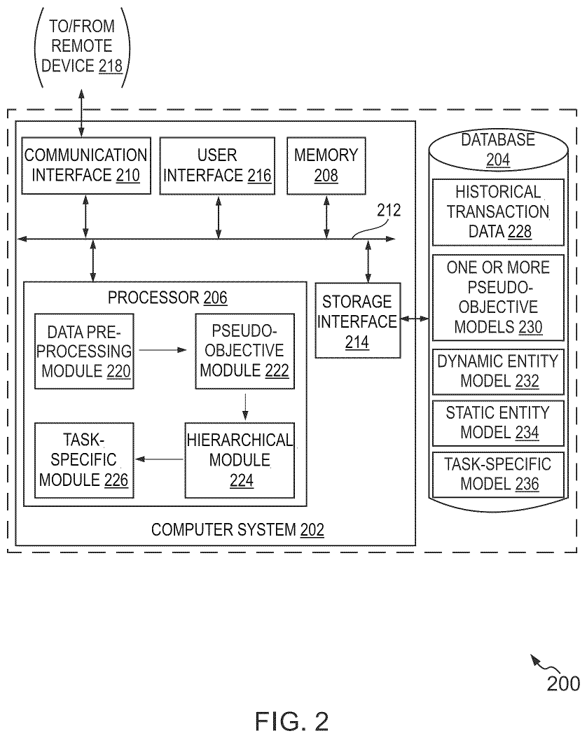

FIG. 2 is a simplified block diagram of a server system 200, in accordance with an embodiment of the present disclosure. The server system 200 is identical to the server system 102 of FIG. 1. In one embodiment, the server system 200 is a part of the payment server 116. In some embodiments, the server system 200 is embodied as a cloud-based and/or SaaS-based (software as a service) architecture. The server system 200 includes a computer system 202 and a database 204. The database 204 is identical to the database 118 of FIG. 1. The computer system 202 includes at least one processor 206 for executing instructions, a memory 208, a communication interface 210, a storage interface 214, and a user interface 216 that communicates with each other via a bus 212.

In some embodiments, the database 204 is integrated into the computer system 202. For example, the computer system 202 may include one or more hard disk drives as the database 204. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one implementation, the database 204 is configured to store historical transaction data 228, one or more pseudo-objective models 230, a dynamic entity model 232, a static entity model 234, and a task-specific model 236. It is noted that the one or more pseudo-objective models 230 is identical to the one or more pseudo-objective models 120 of FIG. 1.

In an embodiment, the historical transaction data 228 refers to transaction-related information corresponding to a plurality of historical transactions performed by the plurality of cardholders 104. The historical transaction data 228 further includes at least the entity-specific data, the cardholder-specific data, and the transaction-specific data. In an example, the cardholder-specific data includes attributes or information corresponding to the plurality of cardholders 104 that perform the plurality of transactions within the payment network 114. In various non-limiting examples, the cardholder-specific data includes attributes related to at least a card number, a card identifier, a product name, a product group name, a product type, and the like.

In an example, the transaction-specific data includes attributes or information corresponding to the plurality of transactions performed between the various entities within the payment network 114. In various non-limiting examples, the transaction-specific data includes attributes related to at least one of the categorical attributes, the numerical attributes, and the meta attributes. In various non-limiting examples, the categorical attributes further include attributes related to at least a cardholder transaction type, a response code, a financial network code, a message type indicator (MTI) code, a transaction status, a cardholder present status code, a card present (CP) code, a card not present (CNP) code, a merchant advice code, a permanent account number (PAN) entry mode code, and the like. In various non-limiting examples, the numerical attributes further include attributes related to at least a transaction date, a transaction time, a local transaction date, a local transaction time, a transaction count, a transaction amount (e.g., in USD), one or more risk scores, and the like. In various non-limiting examples, the meta attributes further include attributes related to at least a process date, a sequence number, a geo-location of the merchant, an internet protocol (IP) address of the merchant, a geo-location of the cardholder, an IP address of the cardholder, and the like.

In an implementation, the entity-specific data may further include acquirer-specific data, merchant-specific data, and issuer-specific data. In an example, the acquirer-specific data includes attributes or information corresponding to the plurality of acquirer servers 108 involved in the plurality of transactions performed between the various entities within the payment network 114. In various non-limiting examples, the acquirer-specific data includes attributes related to at least an acquirer institution identifier (ID), an acquirer ID, an acquirer country code, an acquirer parent access ID, an acquirer parent access name, and the like.

In an example, the merchant-specific data includes attributes or information corresponding to the plurality of merchants 110 involved in the plurality of transactions performed between the various entities within the payment network 114. In various non-limiting examples, the merchant-specific data further includes attributes related to at least a merchant category code (MCC), a merchant country, a merchant ID, a merchant region, a cleansed merchant name, a merchant country code, a merchant market hierarchy ID, an aggregate merchant ID, an aggregate merchant name, an industry, a location ID, a channel of distribution code, and the like.

In an example, the issuer-specific data includes attributes or information corresponding to the plurality of issuers 106 involved in the plurality of transactions performed between the various entities within the payment network 114. In various non-limiting examples, the issuer-specific data further includes attributes related to at least an issuer country code, an issuer ID, an issuer region, an issuer country name, a business region name, a parent access ID, a parent access name, and the like.

In an embodiment, the one or more pseudo-objective models 230 are AI or ML-based models that are generated for each of the plurality of entities based, at least in part, on the historical transaction data and the one or more pseudo-objectives. It is understood that one or more pseudo-objectives are simple tasks for which the AI or ML models can be generated based on an entity type of the entity for which a pseudo-objective model is generated. For instance, the one or more pseudo-objectives may include a task of predicting a gross domestic value (GDV) of a plurality of transactions performed over a certain period of time, a task for performing transaction attribute classification, etc. In various non-limiting examples, the GDV may be a card-level GDV, an issuer-level GDV, an acquirer-level GDV, and a merchant-level GDV. As may be understood, a pseudo-objective model can be generated based on the pseudo-objective for predicting the GDV for a certain period of time. In particular, the pseudo-objective model will try to predict the cumulative amount of transactions that will be performed within a predefined time period. For example, a pseudo-object model for predicting GDV can be trained on the historical transaction data 228 for a time period of 11 months, i.e., January-November, and be required to predict the GDV in the 12^{th} month, i.e., December. It is noted that the embeddings from the layers of the one or more pseudo-objective models 230 that were generated based on the pseudo-objectives for each entity of the plurality of entities describe or define the generalized behavior of each of the plurality of entities in the payment network 114. In some scenarios, the embeddings may be generated using feature engineering techniques such as entity encoding (or entity embedding) that has distributional semantics, has similar similarity scores for similar samples, and provides a dense feature set where each feature is related to the other. To that end, it is understood that the entity-specific embeddings from the one or more pseudo-objective models 230 that learn from the entity-specific data will define the generalized behavior of that specific entity. For instance, the acquirer-specific embeddings from the pseudo-objective models that learn from the acquirer-specific data will define the generalized behavior of the acquirer 108. As may be understood, the one or more pseudo-objective models 230 differ from task-specific AI or ML models (such as task-specific model 236) as the one or more pseudo-objective models 230 don't learn from all of the plurality of entities. In particular, each of the one or more pseudo-objective models 230 is responsible for learning the generalized behavior of each of the plurality of entities.

In one implementation, for generating the one or more pseudo-objective models 230 at first, an entity category of each of the plurality of entities is determined based, at least in part, on the historical transaction data 228. Herein, the entity corresponds to one of the acquirers 108, the merchants 110, and the issuer 106. In particular, the transaction data can be processed for determining the entity category. Then, a desired model type for each of the one or more pseudo-objective models 230 can be determined based, at least in part, on the entity category and each of the one or more pseudo-objectives. For example, if the pseudo-objective is to predict GDV and the entity category is merchant such as the merchant 110a, then a suitable model type for predicting the merchant-level GDV is determined. On the other hand, if the pseudo-objective is to predict a merchant attribute for the next transaction, i.e., a transaction attribute classification task then, a different suitable model type (such as a classification model) is determined. Thereafter, the one or more pseudo-objective models 230 are generated for each of the plurality of entities based, at least in part, on the desired model type and the historical transaction data 228. For instance, the one or more pseudo-objective models 230 for determining the GDV for each of the entities, i.e., the acquirer 108, the merchants 110, and the cardholders 104 are generated using the historical transaction data 228. It is noted that the dynamic entity model 232, the static entity model 234, and the task-specific model 236 have been described later in the present disclosure.

In some embodiments, the processor 206 includes suitable logic, circuitry, and/or interfaces to execute operations for generating task-agnostic and scalable embeddings that can be used in training/generating task-specific models. In other words, the processor 206 includes suitable logic, circuitry, and/or interfaces to execute operations for determining entity-specific embeddings among other tasks. Examples of the processor 206 include, but are not limited to, an application-specific integrated circuit (ASIC) processor, a reduced instruction set computing (RISC) processor, a graphical processing unit (GPU), a complex instruction set computing (CISC) processor, a field-programmable gate array (FPGA), and the like.

The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 218 such as the acquirer server 108, the issuer server 106, the payment server 116, or communicating with any entity connected to the network 112 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one embodiment, the processor 206 includes a data pre-processing module 220, a pseudo-objective module 222, a hierarchical module 224, and a task-specific module 226. It should be noted that components, described herein, such as the data pre-processing module 220, the pseudo-objective module 222, the hierarchical module 224, and the task-specific module 226 can be configured in a variety of configurations, including electronic circuitries, digital arithmetic, and logic blocks, and memory systems in combination with software, firmware, and embedded technologies. Further, it is noted that the components of the processor 206 are communicably coupled with each other and are configured to transmit and receive one or more data elements to/from each other. In one implementation, the processor 206 is configured to run or execute an algorithm (stored in the database 204) to generate task-agnostic and scalable embeddings for training the task-specific model 236.

In an embodiment, the data pre-processing module 220 includes suitable logic and/or interfaces for accessing historical transaction data 228 from a database such as the database 204 associated with the server system 200. As described earlier, the historical transaction data 228 includes the entity-specific data, the cardholder-specific data, and the transaction-specific data. The data pre-processing module 220 is further configured to determine the one or more pseudo-objectives for a task to be performed by the one or more pseudo-objective models 230 based, at least in part, on a set of predefined rules. The set of predefined rules can be defined as rules that help in determining the general behavior of the plurality of entities within the payment network 114. In particular, the set of pre-defined rules is determined based on an internal policy of the server system 200 or the payment server 116. In some scenarios, the set of predefined rules is defined by an administrator of the server system 200. In various non-limiting examples, the one or more pseudo-objectives may include at least one or more of a task for predicting a Gross domestic value (GDV), a task of transaction attribute classification, and the like. In another embodiment, the data pre-processing module 220 is communicably coupled to the pseudo-objective module 222.

In an embodiment, the pseudo-objective module 222 includes suitable logic and/or interfaces for generating or training the one or more pseudo-objective models 230 for each of the plurality of entities based, at least in part, on the historical transaction data 228 and the one or more pseudo-objectives. Herein, the plurality of entities includes at least the acquirer 108, the merchants 110, and the issuer 106. It is noted that the operation of the one or more pseudo-objective models 230 has been explained in detail earlier, therefore the explanation for the same is not repeated for the sake of brevity. It is understood that for determining the model type of the one or more pseudo-objective models 230, the data pre-processing module 220 at first is configured to determine an entity category of each of the plurality of entities based, at least in part, on the historical transaction data 228. Then, the data pre-processing module 220 is configured to determine a desired model type for each of the one or more pseudo-objective models 230 based, at least in part, on the entity category and each of the one or more pseudo-objectives. Thereafter, the data pre-processing module 220 is configured to generate the one or more pseudo-objective models 230 for each of a plurality of entities based, at least in part, on the desired model type and the historical transaction data 228.

In another embodiment, the pseudo-objective module 222 is configured to determine via the one or more pseudo-objective models 230, the entity-specific embeddings for each entity based, at least in part, on the entity-specific data. More specifically, when the one or more pseudo-objective models 230 perform the task set by the one or more pseudo-objectives, they do so by learning the behavior of the entities during the transactions within the payment network 114. This learning is done during the training phase of generating the pseudo-model. Further, this learning of the one or more pseudo-objective models 230 can be extracted in the form of embedding from the various layers within the one or more pseudo-objective models 230. Herein, the entity-specific embeddings include at least one of the acquirer-specific embeddings, the merchant-specific embeddings, and the issuer-specific embeddings. It is understood that the entity-specific embeddings can be defined as generalized embeddings that indicate the general behavior of the entities while in isolation. In other words, the acquirer-specific embeddings, the merchant-specific embeddings, and the issuer-specific embeddings indicate the feature representations of the specific entity that are learned in isolation by the one or more pseudo-objective models 230. As may be understood, learning further from the embeddings specific to an entity controls the number of interactions of the entity within and across other entities in the payment network 114. For instance, the acquirer-specific embeddings are learned from the understanding of the acquirer such as acquirer 108b from the pseudo-objective model.

In another embodiment, the pseudo-objective module 222 is configured to access new entity data associated with the new entity from the database 204 when a request to induct a new entity in the payment network 114 is received from a third party. Herein, the new entity includes transaction data associated with the new entity. In some examples, the third party may be the issuer 106, the acquirer 108, or the payment server 116. In some scenarios, the request for induction can be generated and transmitted by the new entity as well. It is noted that the new entity may transmit the new entity data to the server system 200 along with the request for induction. Thereafter, the new entity data can be stored in the database 204 associated with the server system 200. In an alternative scenario, the pseudo-objective module 222 can be configured to request the new entity for the new entity data.

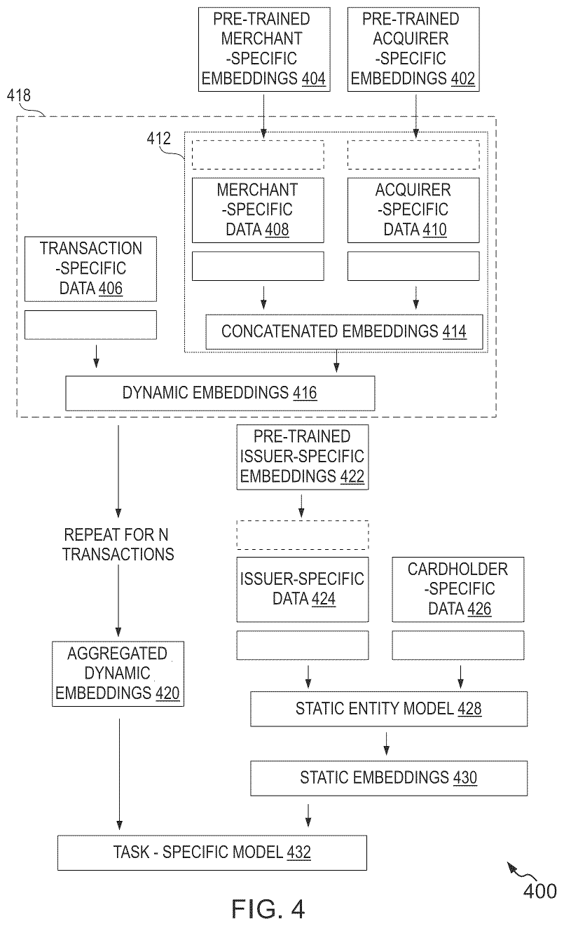

In another embodiment, the pseudo-objective module 222 is configured to determine approximate embeddings corresponding to the new entity based, at least in part, on the new entity data and the entity-specific embeddings. Further, the pseudo-objective module 222 is configured to update one of the entity-specific embeddings based, at least in part, on the approximate embeddings. This aspect has been described further in detail with reference to FIG. 4 later in the present disclosure. In another embodiment, the pseudo-objective module 222 is communicably coupled to the hierarchical module 224.

In an embodiment, the hierarchical module 224 includes suitable logic and/or interfaces for generating dynamic embeddings corresponding to each of a plurality of transactions performed between the plurality of cardholders 104 and the plurality of merchants 110 based, at least in part, on the dynamic attributes associated with dynamic entities within the payment network 114. For instance, the dynamic embeddings are computed for the acquirer 108 and the merchants 110, as the attributes associated with them, are dynamic in nature. In particular, the acquirer-specific embeddings and the merchant-specific embeddings along with the transaction-specific data are used to generate the dynamic embeddings via an AI or ML model. In other words, the pre-trained task agnostic embeddings generated from the one or more pseudo-objective models 230 are used for generating the dynamic embeddings. In a non-limiting example, the dynamic entity model 232 is used for generating the dynamic embeddings corresponding to each of a plurality of transactions. Thereafter, the hierarchical module 224 is configured to generate aggregated dynamic embeddings corresponding to a plurality of transactions based, at least in part, on aggregating each of the dynamic embeddings corresponding to each of the plurality of transactions. In an example, for aggregating each of the dynamic embeddings corresponding to each of a plurality of transactions at least one of a recurrent neural network (RNN), a long short-term memory network (LSTM) model, and a geometric decay network is used. An example of the dynamic entity model 232 is RNN. Herein, the transaction-specific data enables the dynamic entity model 232 to learn the relationship or the interactions between different acquirers 108 and merchants 110 involved in the plurality of transactions. In particular, the dynamic entity model 232 allows entity-specific embeddings, i.e., the merchant-specific embeddings and the acquirer-specific embeddings to interact with themselves in the first few layers of the dynamic entity model 232 then, these entity-specific embeddings concatenated or combined and learned together with the transaction-specific data to generate the dynamic embeddings. It is noted that this process is repeated for N number of transactions to refine or fine-tune the dynamic embeddings. Herein, ‘N’ is a natural number, wherein ‘N’ is non-zero. Thereafter, the dynamic embeddings corresponding to each of the N number of transactions are aggregated to generate the aggregated dynamic embeddings. Taking an example of the acquirer-specific embeddings that are learned from the understanding of the acquirer such as the acquirer 108b first before learning about the interaction between the acquirer 108b and other entities such as other acquires and the merchants (this is done using the dynamic entity model 232). For instance, the dynamic entity model 232 learns/understands the interactions between the acquirer 108b and the other acquirers within the transaction structure such as the acquirer 108a and the acquire 108c. In other words, the entity-specific embeddings allow the server system 102 to learn the behavior of an entity (such as the acquirer 108b) first (this is done by the pseudo-objective module 222 as described earlier). This is known as abstraction at the entity level. It is noted that in the context of the transaction data, i.e., temporal in nature, abstraction is enforced by logical entity-driven transaction structure. Then, the dynamic entity model 232 understands how a particular entity interacts with other dynamic entities in the payment network 114 in the context of the transaction data. Further, learning from each of plurality of transactions is aggregated in the form of aggregated dynamic embeddings. This process is known as hierarchical interactions. This aspect has been described further in detail with reference to FIG. 4 later in the present disclosure.

In another embodiment, the hierarchical module 224 is configured to generate the static embeddings based, at least in part, on the static attributes associated with the static entities within the payment network 114. For instance, the static embeddings are computed for the issuer and the cardholder, as the attributes associated with them are static in nature. In particular, the issuer-specific embeddings and the cardholder-specific data are used to generate the static embeddings via an AI or ML model. In other words, the pre-trained task agnostic static embeddings generated from the one or more pseudo-objective models 230, i.e., the issuer-specific embeddings are used for generating the static embeddings. In a non-limiting example, the static entity model 234 is used for generating the static embeddings. Herein, the transaction-specific data enables the static entity model 234 to learn the relationship or the interactions between different issuers 106 and cardholders 104. In particular, the static entity model 234 allows the entity-specific embeddings, i.e., the issuer-specific embeddings to interact with itself in the first few layers of the static entity model 234. Then, these issuer-specific embeddings are learned together with the cardholder-specific data to generate the static embeddings. This aspect has been described further in detail with reference to FIG. 4 later in the present disclosure. In another embodiment, the hierarchical module 224 is communicably coupled to the task-specific module 226.

In an embodiment, the task-specific module 226 includes suitable logic and/or interfaces for generating the task-specific model 236 based, at least in part, on the aggregated dynamic embeddings and the static embeddings. The task-specific model 236 is an AI or ML model that is configured to perform any specific task based on learnings from the dynamic embeddings and the static embeddings. In various non-limiting examples, the tasks that the task-specific model 236 may perform include at least any of fraud detection, authentication optimization, fraud classification, predicting entity behavior in the future, predicting chargeback rate for a transaction, and the like. It is understood that the learnings of embeddings are transferable in nature and since the aggregated dynamic embeddings and the static embeddings are task-agnostic-embeddings, therefore these embeddings can be used to train the task-specific model 236. In other words, the embeddings from the one or more pseudo-objective models 230 serve as a starting point for the actual task to be performed by the task-specific model 236.

In one non-limiting implementation, the task-specific model 236 may be an authorization optimization model that is configured to recommend the optimal timing for retrying a card after it faces a recurring non-sufficient fund (NSF) decline on a merchant. In other words, the model objective is to predict the days to first approval on a card after it faces a recurring NSF decline. It is understood that the performance of such tasks is improved when the task-specific model 236 is trained on the aggregated dynamic embeddings and the static embeddings as the first input to the model. An experiment describing the performance improvements associated with the described approach has been described in detail later in the present disclosure.

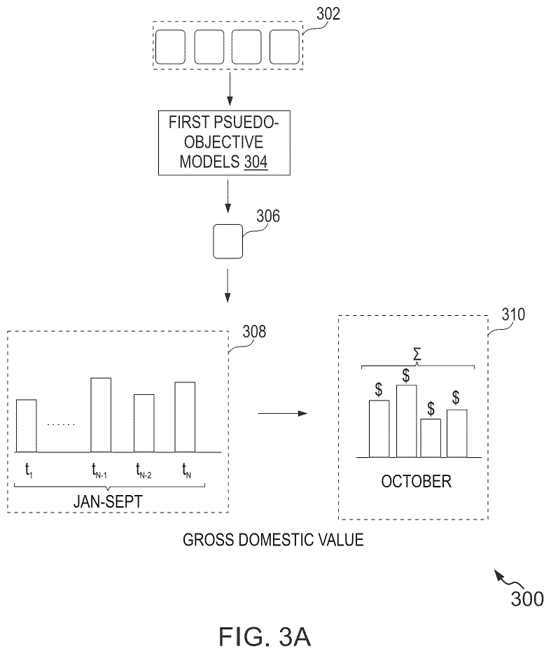

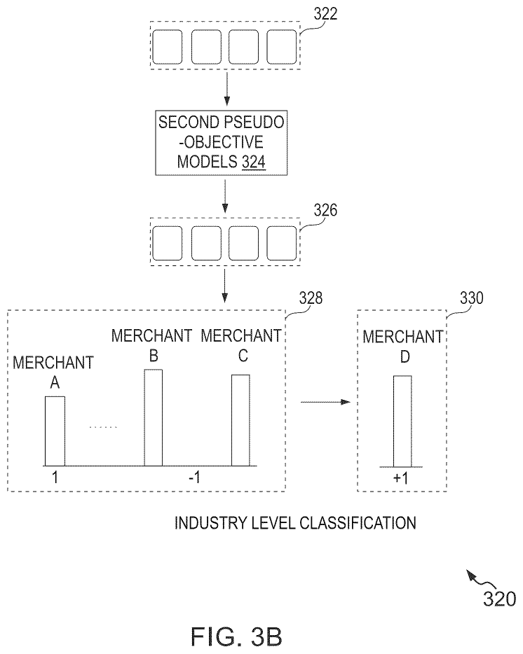

FIG. 3A illustrates a block diagram 300 of a first pseudo-objective model 304 for predicting a monthly Gross domestic value (GDV) for a certain time period, in accordance with an embodiment of the present disclosure.

In an embodiment, the first pseudo-objective model 304 is generated by the pseudo-objective module 222 of the server system 200. The first pseudo-objective model 304 is generated based on the pseudo-objective of predicting the monthly GDV for a certain time period using the historical transaction data 228 for each of the plurality of entities. In other words, GDV is predicted for each of the entities, i.e., GDV is predicted at the issuer level, the acquirer level, the cardholder level, and the merchant level. In a non-limiting example, the model type of the first pseudo-objective model 304 is an LSTM model. However, as described earlier, the desired model type of the one or more pseudo-objective models (e.g., the first pseudo-objective model 304) is determined based, at least in part, on the entity category and each of the one or more pseudo-objectives. In other words, the model type can be different as well.

As depicted in FIG. 3A, an input 302 is fed to the first pseudo-objective model 304 to generate an output 306. In particular, the input 302 of the first pseudo-objective model 304 are entity-related transactional attributes extracted from the historical transaction data 228. Further, the output generated by the first pseudo-objective model 304 is the monthly GDV including GDV for a known time period (see, 308) and a predicted GDV for another time period (see, 310). In the depicted example, the first pseudo-objective model 304 is trained on the transactional attributes of an entity for the time period of January to September while the predictions are made for the month of October.

FIG. 3B illustrates a block diagram 320 of a second pseudo-objective model 324 for predicting an industry-level classification of a merchant, in accordance with an embodiment of the present disclosure.

In an embodiment, the second pseudo-objective model 324 is generated by the pseudo-objective module 222 of the server system 200. The second pseudo-objective model 324 is generated based on the pseudo-objective of predicting the industry classification of the merchant using the historical transaction data 228. In non-limiting examples, the industry classification can be done to predict super industry, industry, merchant category code (MCC), or a merchant of a future transaction. In a non-limiting example, the model type of the second pseudo-objective model 324 is the LSTM model. However, as described earlier, the model type can be different as well as per requirements.

As depicted in FIG. 3B, an input 322 is fed to the second pseudo-objective model 324 to generate an output 326. In particular, the input 322 of the first pseudo-objective model 304 are entity-related transactional attributes extracted from the historical transaction data 228. Further, the output 326 generated by the second pseudo-objective model 324 is a prediction of which merchant, the cardholder is likely to transact at next.

In the depicted example, the second pseudo-objective model 324 is trained on the transactional attributes of various entities to determine that the cardholder has transacted from a merchant A to a merchant B and a merchant C (see, 328). Then, the second pseudo-objective model 324 may predict that the cardholder will transact at the merchant D in their next transaction (see, 330). In some scenarios, the prediction may only determine the MCC, industry, or super industry of the merchant D, instead of predicting the exact merchant.

As may be understood, the entity-specific embeddings can be extracted from the layers of the pseudo-objective models such as the first and second pseudo-objective models 304 and 324. These embeddings are learned during the training process of the pseudo-objective model. For example, if the input is merchant-related attributes from the historical transaction data 228 (i.e., within the entity-specific data) then, the output is the merchant-specific embeddings trained using monthly GDV pseudo-objective. In other words, the actual prediction of the pseudo-model is not the desired output rather it is the learnings from training the pseudo-objective model that is described. As a result, these embeddings are task-agnostic in nature and describe the generalized behavior of the various entities within the payment network 114.

FIG. 4 illustrates a simplified block diagram 400 for generating a task-specific model 432 from the task-agnostic embeddings (i.e., dynamic and static embeddings) learned from a plurality of entities (i.e., the merchant, the acquirer, and the issuer) within the payment network 114, in accordance with an embodiment of the present disclosure.

In an embodiment, the server system 200 is configured to access the pre-trained acquirer-specific embeddings 402, the pre-trained merchant-specific embeddings 404, and the pre-trained issuer-specific embeddings 422 from the one or more pseudo-objective models 230. For instance, the pre-trained merchant-specific embeddings 404, and the pre-trained acquirer-specific embeddings 402 can be extracted from any of the pseudo-objective models (i.e., the first pseudo-objective model 304 or the second pseudo-objective model 324) shown in FIGS. 3A-3B). As described earlier, the entity-specific embeddings are generalized embeddings that indicate the general behavior of the entities while in isolation. In other words, the pre-trained acquirer-specific embeddings 402, the pre-trained merchant-specific embeddings 404, and the pre-trained acquirer-specific embeddings 402 indicate the feature representations of the specific entity that are learned in isolation by the one or more pseudo-objective models 230.

As described earlier with reference to FIG. 2, the server system 200 is configured to learn from the embeddings specific to an entity and controls the number of interactions of the entity within and across other entities in the payment network 114. For instance, the learning of the dynamic entities is done by the dynamic entity model 232 for each transaction out of ‘N’ number of transactions based, at least in part, on the dynamic entity-specific embeddings, i.e., the acquirer-specific embeddings and the merchant-specific embeddings along with the transaction-specific data 406.

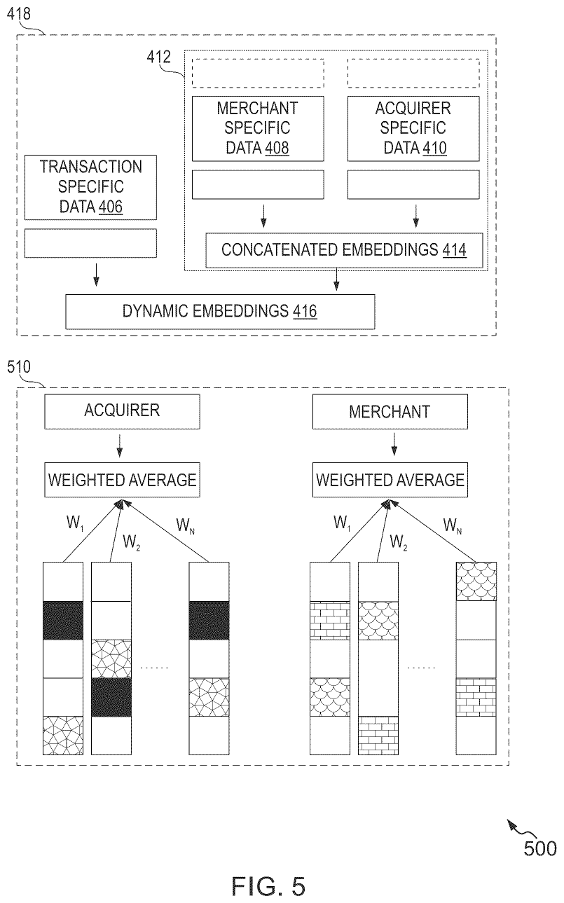

For instance see, block 418 representing a single transaction view for generating dynamic embeddings for a single transaction. As depicted, the dynamic entity model 232 allows the entity-specific embeddings, i.e., the pre-trained merchant-specific embeddings 404 and the pre-trained acquirer-specific embeddings 402 to interact with entity-specific data, i.e., merchant-specific data 408 and acquirer-specific data 410 individually to generate the merchant-specific embeddings and the acquirer-specific embeddings. In other words, the pre-trained dynamic entity-specific embeddings interact with the dynamic entity-specific data to generate dynamic entity-specific embeddings. Thereafter, the merchant-specific embeddings and the acquirer-specific embeddings are concatenated to generate concatenated embeddings 414. In other words, the merchant-specific embeddings and the acquirer-specific embeddings interact with each other to generate the concatenated embeddings 414. Further, these concatenated embeddings 414 interact with the transaction-specific data 406 to generate the dynamic embeddings 416. Herein, the transaction-specific data 406 enables the dynamic entity model 232 to learn the relationship or the interactions between different acquirers 108 and merchants 110 for a transaction. Further, this process of generating dynamic embeddings 416 is repeated for N number of transactions to generate N number of dynamic embeddings. In other words, the described process for generating the dynamic embeddings 416 has to be repeated for the ‘N’ number of transactions to aggregate the dynamic embeddings corresponding to each of the N transactions. Herein, ‘N’ is a non-zero natural number. In other words, the process described by block 418 is repeated for the N number of transactions to generate an N number of dynamic embeddings. Thereafter, these N number of dynamic embeddings are aggregated to generate the aggregated dynamic embeddings 420. It is understood that the aggregated dynamic embeddings 420 represent an aggregated learning from each transaction of the N transactions. In an example, for aggregating the dynamic embeddings for N transactions one of a recurrent neural network (RNN) or a long short-term memory network (LSTM) model may be used, a geometric decay network can be used for faster training and inference generation (i.e., dynamic embedding generation). As may be understood, since the RNN, the LSTM, and the geometric decay network are scalable in nature, therefore the dynamic entity model 232 is also scalable in nature. In other words, the dynamic entity model 232 does not suffer from any scalability issues and can easily learn new embeddings when new dynamic entities are introduced in the payment network. It is noted the process of generating the aggregated dynamic embeddings using the geometric decay based approach is even faster and resource efficient than relying on the RNN or LSTM based models (these models are also scalable but slow in operation when new entities are introduced). It is noted that the process of generating new aggregated embeddings using geometric decay when a new entity is introduced in the payment network is described later with reference to FIG. 5.

Returning back to the previous example, while learning from the pre-trained acquirer-specific embeddings 402 from different acquirers from a plurality of acquirers 108, the dynamic entity model 232 first learns about the interactions between acquirers involved in the plurality of payment transactions. For instance see, block 418 wherein, the dynamic entity model 232 learns/understands the interactions between the acquirer 108b and the other acquirers within the transaction structure such as the acquirer 108a and the acquirer 108c from the pre-trained acquirer-specific embeddings 402 corresponding to the acquirer 108a, 108b, and 108c. Then, the dynamic entity model 232 learns/understands how a particular entity interacts with other entities in the payment network 114. For instance, the dynamic entity model 232 learns/understands the interactions between acquirers and other dynamic entities such as the merchant. Further, the embeddings from the learnings of each of the dynamic entities are concatenated. Thereafter, the dynamic entity model 232 generates dynamic embeddings 416 by learning the interaction/relation between the concatenated embeddings 414 using the transaction-specific data 406. This process is repeated for N number of transactions to generate N number of dynamic embeddings. These N number of dynamic embeddings can be aggregated to generate the aggregated dynamic embeddings 420.

Furthermore, as described earlier with reference to FIG. 2, the server system 200 is configured to learn from the embeddings specific to static entities in the payment network 114. For instance, the learning of the static entities is done by the static entity model 234 for each transaction out of N number of transactions based, at least in part, on the static entity-specific embeddings, i.e., the issuer-specific embeddings along with the cardholder-specific data 426. As may be understood, static embeddings are computed at the cardholder level and thus, the cardholder and the issuer will remain the same or static during the learning process for generating the static entities.

Particularly, the static entity model 234 allows entity-specific embeddings, i.e., the issuer-specific embeddings 424 to interact with themselves in the first few layers of the static entity model 428 then, these issuer-specific embeddings 424 are learned together with the cardholder-specific data 426 to generate the static embeddings 430. Herein, the cardholder-specific data 426 enables the static entity model 428 to learn the relationship or the interactions between the issuer associated with the cardholder and the same cardholder that is involved in the plurality of transactions. It is noted that this process is repeated for N number of transactions performed with the cardholder to refine or fine-tune the static embeddings 428. Herein, ‘N’ is a natural number, wherein ‘N’ is non-zero. Furthermore, the aggregated dynamic embeddings 420 and the static embeddings 430 from the static entity model 428 are used to generate the task-specific model 432. In various non-limiting examples, the task-specific model 432 can be an AI or ML model that is configured to perform a specific task such as, but not limited to, fraud detection, authentication optimization, fraud classification, predicting entity behavior in the future, predicting chargeback rate for a transaction, and the like.

In a non-limiting example, an algorithm for training the task-specific machine learning model using dynamic and static embeddings is given below:

Training phase:

1. Training one or more pseudo-objective models for learning entity-
specific embeddings (called, pre-trained entity-specific embeddings);
2. Initiating the training phase with pre-trained entity-specific
embeddings shown in block 418 of FIG. 4;
3. Determining dynamic embeddings for each transaction of N
transactions;
4. Determine aggregate dynamic embeddings for N transactions;
5. Determine static embeddings;
6. Train a task-specific model based on the dynamic embeddings and
the static embeddings.

It is understood that learning the dynamic embeddings and static embeddings separately reduces the noise when generating the embeddings. This further helps to improve the performance of any task-specific model that based be generated or trained using these separately learned dynamic embeddings and static embeddings. The same has been confirmed with the help of various experiments. The results of various such experiments are given below in Table 1. In particular, the experiment process included generating different instances of a task-specific model using the conventional approach and the proposed approach. Further, further prediction accuracy, the F1 weighted score, and the F2 weighted score of these different instances of the task-specific model were computed. In particular, the task-specific model in the performed experiments corresponded to an Authorization Optimization task. In this task, the task-specific model had to recommend, i.e., predict the optimal time for retrying a payment transaction with a payment card after it faces recurring declines due to non-sufficient funds (NSF) with a merchant. The Authorization Optimization model (i.e., the task-specific model used in these experiments) was constructed as a seven-class classification problem with each class indicating when to retry the transaction that was previously declined due to NSF. The results pertaining to the accuracy, the F1 weighted score, and the F2 weighted score for different instances of the Authorization Optimization model are shown in Table. 1. As may be understood from these results, each of the instances where pre-trained embeddings are used shows significant improvement for every category, i.e., the accuracy, the F1 weighted score, and the F2 weighted score.

| Pre-trained | Model | Pseudo- | | | F1 | F2 |
|---|---|---|---|---|---|---|
| embedding | type | objective | Averaging | Accuracy | weighted | weighted |
| No | LSTM | None | — | 36.76% | 28.78 | 32.69% |
| No | LSTM | None | — | 38.61% | 32.71% | 35.90% |
| Yes | LSTM | Industry | — | 38.98% | 33.63% | 36.50% |
| | | classification | | | | |
| Yes | LSTM | Card-level | — | 39.09% | 33.43% | 36.51% |
| Yes | — | GDV | Simple | 39.80% | 31.87% | 36.10% |
| | | | averaging | | | |
| Yes | — | | Geometric | 41.14% | 33.14% | 37.44% |
| | | | decaying | | | |
| | | | averaging | | | |

In an embodiment, the server system 200 is configured to receive a request to induct a new entity within the payment network 114. It is understood that the new entity can be one of a new acquirer, a new issuer, and a new merchant. In conventional models, when new entities are introduced within the payment network 114, these models have to be retrained from scratch. This problem is known as the cold start problem. However, this problem is addressed by the server system 200. To that end, at first, the server system 200 is configured to access the new entity data associated with the new entity from the database 204. In an example, the new entity data includes at least transaction attributes or data associated with the new entity. In an embodiment, the server system 200 is configured to request the new entity data from the new entity and store the received entity data in the database 204 associated with the server system 200. Thereafter, the server system 200 determines a new entity category of the new entity based, at least in part, on the new entity data. In other words, the server system 200 determines if the new entity has a new entity category corresponding to one of a new acquirer, a new merchant, and a new issuer. Further, the server system 200 is configured to determine approximate embeddings corresponding to the new entity. Furthermore, the server system 200 is configured to concatenate or aggregate the determined approximate embeddings with one of the aggregated dynamic embeddings 420 and the static embeddings 430 to generate one of the new aggregated dynamic embeddings and new static embeddings. In other words, the server system 200 is configured to update one of the entity-specific embeddings based, at least in part, on the determined approximate embeddings. As may be understood, now the new aggregated dynamic embeddings or the new static embeddings can be used along with the previously determined embeddings for training or training the task-specific 432.

It is noted the process of determining the approximate embeddings corresponding to the new entity includes at first determining by the server system 200, a geo-location of the new entity based, at least in part, on the new entity data. Then, the server system 200 determines one or more neighboring entities with an identical entity category to the new entity category based, at least in part, on the transaction-specific data. It is noted that, as described earlier, the transaction-specific data includes the meta attributes. In various non-limiting examples, the meta attributes further include attributes related to at least a process date, a sequence number, a geo-location of the merchant, an internet protocol (IP) address of the merchant, a geo-location of the cardholder, an IP address of the cardholder, and the like.

Further, the server system 200 accesses one or more entity-specific embeddings associated with the one or more neighboring entities based, at least in part, the entity-specific embeddings. In particular, one or more entity-specific embeddings are extracted from the entity-specific embeddings for the one or more neighboring entities. Thereafter, the server system 200 is configured to compute an average of the one or more entity-specific embeddings associated with the one or more neighboring entities to determine the approximate embeddings corresponding to the new entity. As may be understood, since it is common for new dynamic entities to join the payment eco-system, the scalable nature of the dynamic machine learning model 232 plays a significant role in saving time and processing resources compared to any conventional technique that suffers from the cold-start problem.

FIG. 5 illustrates a simplified block diagram 500 for aggregating dynamic embeddings via a geometric decay network, in accordance with an embodiment of the present disclosure.

As described earlier, using RNN or LSTM based models for aggregating the dynamic embeddings generated for the N transactions makes the aggregation process complex while increasing the processing requirements. To that end, in order to reduce the complexity and the increased requirement for processing resources, a geometric decay network (or simply ‘geometric decay’) may be used. As may be understood, using the geometric decay accelerates the model training and inference learning process for the task-specific model using the dynamic embeddings generated for each of the N transactions. However, it is noted that although the geometric decay accelerates the training and learning process, this comes at the cost of reduced performance. When a geometric decay is applied for aggregating the dynamic embeddings for N transactions, the geometric decay combines or aggregates the embeddings of the previous transaction with the new transaction using an exponentially decaying weighted average. Herein, more importance is given to the latest transactions while less importance is given to the transactions that took place in the past. In other words, higher weights are assigned to the latest transactions, and lower weights are assigned to the transactions in the distant past. This is known as recency bias. In a non-limiting example, the assignment of weights is done using the geometric decay factor given below:

$${w}_{N - i} = {2}^{( \frac{- 8}{N} ) i}$$

Herein, w is the weight associated with the dynamic embeddings corresponding to a transaction. Further, N denotes the number of transactions for which embeddings have to be aggregated and the subscript ‘i’ is used to calculate the weight for i^{th} transaction from N transactions. In a non-limiting example, the aggregating the dynamic embeddings using geometric decay computes the aggregated dynamic embeddings by computing a weighted sum of dynamic embeddings corresponding to the N transactions. For example, w₁*N₁+w₂*N₂+w₃*N₃ . . . ws_{N}*N_{N}.

As depicted by FIG. 5, the dynamic embeddings 416 for a particular transaction of N transactions is computed by block 418 described earlier with reference to FIG. 4. This process is repeated for N transactions to generate N dynamic embeddings. Thereafter, the generation of aggregated dynamic embeddings is performed using the weighted average (shown in block 510).

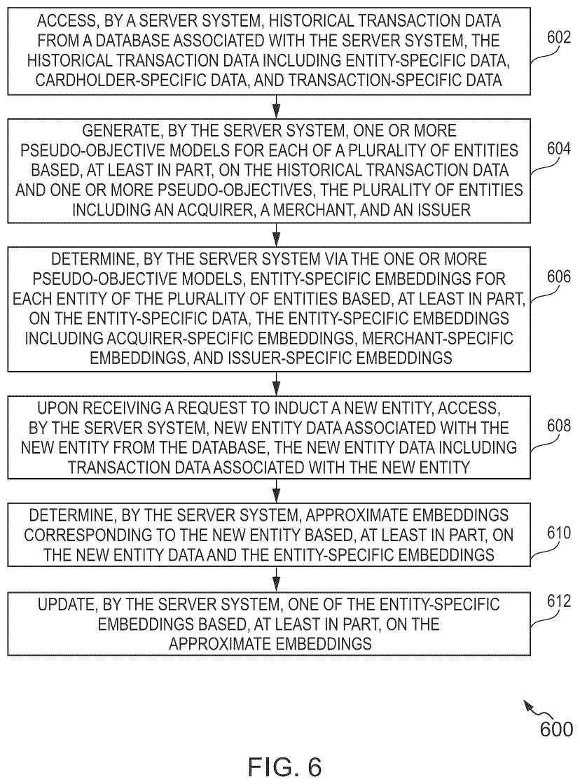

FIG. 6 illustrates a method 600 for updating the entity-specific embeddings when a new entity is inducted in a payment network 114, in accordance with an embodiment of the present disclosure. The sequence of operations of the method 600 may not be necessarily executed in the same order as they are presented. Further, one or more operations may be grouped together and performed in the form of a single step, or one operation may have several sub-steps that may be performed in parallel or in a sequential manner. It is noted that the operations of the method 600, and combinations of operations in the method 600, may be implemented by, for example, hardware, firmware, a processor, circuitry, and/or a different device associated with the execution of software that includes one or more computer program instructions. The method 600 starts at operation 602.

At 602, the method 600 includes accessing, by a server system such as a server system 200, historical transaction data such as historical transaction data 228 from a database such as the database 204 associated with the server system 200. The historical transaction data 228 includes at least entity-specific data, cardholder-specific data, and transaction-specific data.

At 604, the method 600 includes generating, by the server system 200, one or more pseudo-objective models such as one or more pseudo-objective models 230 for each of a plurality of entities based, at least in part, on the historical transaction data 228 and one or more pseudo-objectives. The plurality of entities includes an acquirer, a merchant, and an issuer.

At 606, the method 600 includes determining, by the server system 200 via the one or more pseudo-objective models 230, entity-specific embeddings for each entity of the plurality of entities based, at least in part, on the entity-specific data. The entity-specific embeddings include at least acquirer-specific embeddings, merchant-specific embeddings, and issuer-specific embeddings.

At 608, the method 600 includes upon receiving a request to induct a new entity, accessing, by the server system 200, new entity data associated with the new entity from the database 204. The new entity data includes transaction data associated with the new entity.

At 610, the method 600 includes determining, by the server system 200, one of the entity-specific embeddings approximate embeddings corresponding to the new entity based, at least in part, on the new entity data and the entity-specific embeddings.

At 612, the method 600 includes updating, by the server system 200, based, at least in part, on the approximate embeddings.

The sequence of operations of the method 600 need not be necessarily executed in the same order as they are presented. Further, one or more operations may be grouped together and performed in the form of a single step, or one operation may have several sub-steps that may be performed in parallel or in a sequential manner.

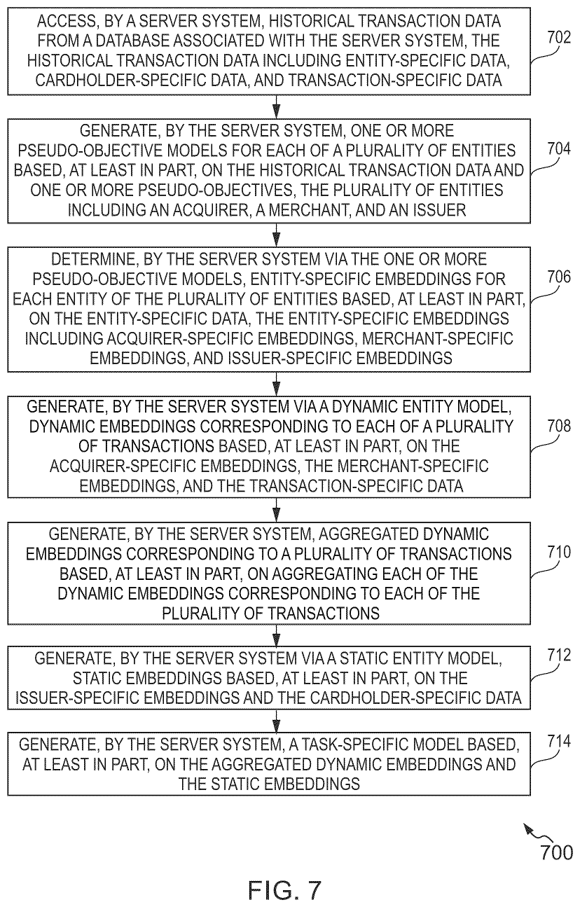

FIG. 7 illustrates a method 700 for generating (or training) a task-specific model (such as the task-specific model 236), in accordance with an embodiment of the present disclosure. The sequence of operations of the method 700 may not be necessarily executed in the same order as they are presented. Further, one or more operations may be grouped together and performed in the form of a single step, or one operation may have several sub-steps that may be performed in parallel or in a sequential manner. It is noted that the operations of the method 700, and combinations of operations in the method 700, may be implemented by, for example, hardware, firmware, a processor, circuitry, and/or a different device associated with the execution of software that includes one or more computer program instructions. The method 700 starts at operation 702.

At 702, the method 700 includes accessing, by a server system such as the server system 200, historical transaction data such as historical transaction data 228 from a database such as the database 204 associated with the server system 200. The historical transaction data 228 includes at least entity-specific data, cardholder-specific data, and transaction-specific data.

At 704, the method 700 includes generating, by the server system 200, one or more pseudo-objective models such as one or more pseudo-objective models 230 for each of a plurality of entities based, at least in part, on the historical transaction data 228 and one or more pseudo-objectives. The plurality of entities includes an acquirer, a merchant, and an issuer.

At 706, the method 700 includes determining, by the server system 200 via the one or more pseudo-objective models 230, entity-specific embeddings for each entity of the plurality of entities based, at least in part, on the entity-specific data. The entity-specific embeddings include at least acquirer-specific embeddings, merchant-specific embeddings, and issuer-specific embeddings.

At 708, the method 700 includes generating, by the server system 200 via a dynamic entity model such as dynamic entity model 232, dynamic embeddings corresponding to each of a plurality of transactions based, at least in part, on the acquirer-specific embeddings, the merchant-specific embeddings, and the transaction-specific data.

At 710, the method 700 includes generating, by the server system 200, aggregated dynamic embeddings corresponding to a plurality of transactions based, at least in part, on aggregating each of the dynamic embeddings corresponding to each of the plurality of transactions.

At 712, the method 700 includes generating, by the server system 200 via a static entity model such as static entity model 234, static embeddings based, at least in part, on the issuer-specific embeddings and the cardholder-specific data.

At 714, the method 700 includes generating, by the server system 200, a task-specific model 236 based, at least in part, on the aggregated dynamic embeddings and the static embeddings.

The sequence of operations of the method 700 need not be necessarily executed in the same order as they are presented. Further, one or more operations may be grouped together and performed in the form of a single step, or one operation may have several sub-steps that may be performed in parallel or in a sequential manner.

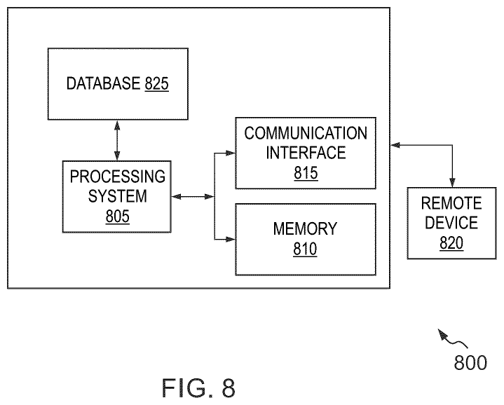

FIG. 8 is a simplified block diagram of a payment server 800, in accordance with an embodiment of the present disclosure. The payment server 800 is an example of the payment server 116 of FIG. 1. The payment server 800 and the server system 200 may use the payment network 114 as a payment interchange network. Examples of payment interchange networks include, but are not limited to, Mastercard® payment system interchange network.

The payment server 800 includes a processing system 805 configured to extract programming instructions from a memory 810 to provide various features of the present disclosure. The components of the payment server 800 provided herein may not be exhaustive and the payment server 800 may include more or fewer components than that depicted in FIG. 8. Further, two or more components may be embodied in one single component, and/or one component may be configured using multiple sub-components to achieve the desired functionalities. Some components of the payment server 800 may be configured using hardware elements, software elements, firmware elements, and/or a combination thereof.

Via a communication interface 815, the processing system 805 receives a request from a remote device 820, such as the issuer server 106 or the acquirer server 108. The request may be a request for conducting the payment transaction. The communication may be achieved through API calls, without loss of generality. The payment server 800 includes a database 825. The database 825 also includes transaction processing data such as an issuer ID, a country code, an acquirer ID, and a merchant identifier (MID), among others.

When the payment server 800 receives a payment transaction request from the acquirer server 108 or a payment terminal (e.g., point of sale (POS) device, etc.), the payment server 800 may route the payment transaction request to an issuer server (e.g., the issuer server 106). The database 825 stores transaction identifiers for identifying transaction details such as the transaction amount, payment card details, acquirer account information, transaction records, merchant account information, and the like.

In one example, the acquirer server 108 is configured to send an authorization request message to the payment server 800. The authorization request message includes, but is not limited to, the payment transaction request.

The processing system 805 further sends the payment transaction request to the issuer server 106 for facilitating the payment transactions from the remote device 820. The processing system 805 is further configured to notify the remote device 820 of the transaction status in the form of an authorization response message via the communication interface 815. The authorization response message includes, but is not limited to, a payment transaction response received from the issuer server 106. Alternatively, in one embodiment, the processing system 805 is configured to send an authorization response message for declining the payment transaction request, via the communication interface 815, to the acquirer server 108.

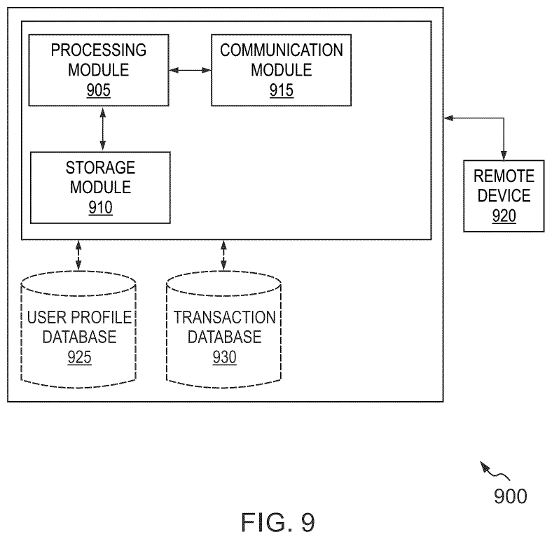

FIG. 9 illustrates a simplified block diagram of the acquirer server 900, in accordance with an embodiment of the present disclosure. The acquirer server 900 is an example of the acquirer server 108 of FIG. 1. The acquirer server 900 is associated with an acquirer bank/acquirer, in which a merchant may have an account, which provides a payment card. The acquirer server 900 includes a processing module 905 operatively coupled to a storage module 910 and a communication module 915. The components of the acquirer server 900 provided herein may not be exhaustive and the acquirer server 900 may include more or fewer components than those depicted in FIG. 9. Further, two or more components may be embodied in one single component, and/or one component may be configured using multiple sub-components to achieve the desired functionalities. Some components of the acquirer server 900 may be configured using hardware elements, software elements, firmware elements, and/or a combination thereof.

The storage module 910 is configured to store machine-executable instructions to be accessed by the processing module 905. Additionally, the storage module 910 stores information related to, the contact information of the merchant, bank account number, availability of funds in the account, payment card details, transaction details, and/or the like. Further, the storage module 910 is configured to store payment transactions.

In one embodiment, the acquirer server 900 is configured to store profile data (e.g., an account balance, a credit line, details of the cardholders 104, account identification information, and a payment card number) in a transaction database 930. The details of the cardholders 104 may include, but are not limited to, name, age, gender, physical attributes, location, registered contact number, family information, alternate contact number, registered e-mail address, etc.

The processing module 905 is configured to communicate with one or more remote devices such as a remote device 920 using the communication module 915 over a network such as the network 112 of FIG. 1. The examples of the remote device 920 include the server system 102, the payment server 116, the issuer server 106, or other computing systems of the acquirer server 900, and the like. The communication module 915 is capable of facilitating such operative communication with the remote devices and cloud servers using API (Application Program Interface) calls. The communication module 915 is configured to receive a payment transaction request performed by the cardholders 104 via the network 112. The processing module 905 receives payment card information, a payment transaction amount, customer information, and merchant information from the remote device 920920 (i.e., the payment server 116). The acquirer server 900 includes a user profile database 925 and the transaction database 930 for storing transaction data. The user profile database 925 may include information associated with the cardholders 104. The transaction data may include, but is not limited to, transaction attributes, such as transaction amount, source of funds such as bank or credit cards, transaction channel used for loading funds such as POS terminal or ATM device, transaction velocity features such as count and transaction amount sent in the past x days to a particular user, transaction location information, external data sources, and other internal data to evaluate each transaction.

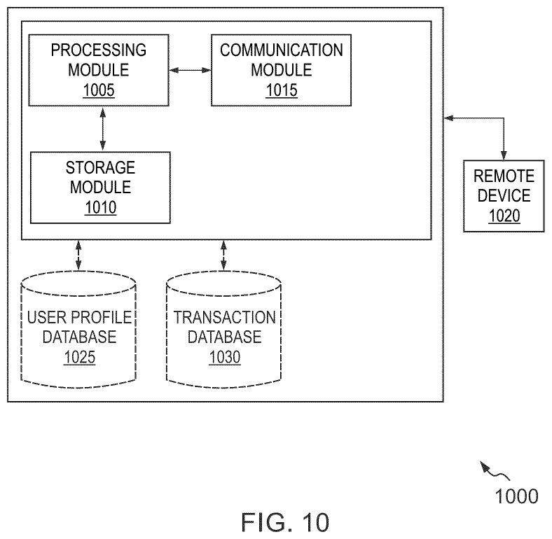

FIG. 10 illustrates a simplified block diagram of the issuer server 1000, in accordance with an embodiment of the present disclosure. The issuer server 1000 is an example of the issuer server 106 of FIG. 1. The issuer server 1000 is associated with an issuer bank/issuer, in which an account holder (e.g., the plurality of cardholders 104a-104c) may have an account, which provides a payment card such as a debit or credit card. The issuer server 1000 includes a processing module 1005 operatively coupled to a storage module 1010 and a communication module 1015. The components of the issuer server 1000 provided herein may not be exhaustive and the issuer server 1000 may include more or fewer components than those depicted in FIG. 10. Further, two or more components may be embodied in one single component, and/or one component may be configured using multiple sub-components to achieve the desired functionalities. Some components of the issuer server 1000 may be configured using hardware elements, software elements, firmware elements, and/or a combination thereof.

The storage module 1010 is configured to store machine-executable instructions to be accessed by the processing module 1005. Additionally, the storage module 1010 stores information related to, the contact information of the cardholders (e.g., the plurality of cardholders 104), a bank account number, availability of funds in the account, payment card details, transaction details, payment account details, and/or the like. Further, the storage module 1010 is configured to store payment transactions.

In one embodiment, the issuer server 1000 is configured to store profile data (e.g., an account balance, a credit line, details of the cardholders 104, account identification information, payment card number, etc.) in a database. The details of the cardholders 104 may include, but are not limited to, name, age, gender, physical attributes, location, registered contact number, family information, alternate contact number, registered e-mail address, or the like of the cardholders 104, etc.

The processing module 1005 is configured to communicate with one or more remote devices such as a remote device 1020 using the communication module 1015 over a network such as the network 112 of FIG. 1. Examples of the remote device 1020 include the server system 200, the payment server 116, the acquirer server 108 or other computing systems of the issuer server 1000. The communication module 1015 is capable of facilitating such operative communication with the remote devices and cloud servers using API (Application Program Interface) calls. The communication module 1015 is configured to receive a payment transaction request performed by an account holder (e.g., the cardholder 104a) via the network 112. The processing module 1005 receives payment card information, a payment transaction amount, customer information, and merchant information from the remote device 1020 (e.g., the payment server 116). The issuer server 1000 includes a transaction database 1030 for storing transaction data. The issuer server 1000 includes a user profile database 1025 storing user profiles associated with the plurality of account holders.

The user profile data may include an account balance, a credit line, details of the account holders, account identification information, payment card number, or the like. The details of the account holders (e.g., the plurality of cardholders 104a-104c) may include, but are not limited to, name, age, gender, physical attributes, location, registered contact number, family information, alternate contact number, registered e-mail address, or the like of the cardholders 104.

The disclosed methods with reference to FIGS. 1 to 7, or one or more operations of the methods 600 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Webbook, tablet computing device, smartphone, or other mobile computing devices)). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc. described herein may be enabled and operated using hardware circuitry (for example, complementary metal-oxide-semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 200 (or the server system 102) and its various components such as the computer system 202 and the database 204 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), compact disc read-only memory (CD-ROM), compact disc recordable (CD-R), compact disc rewritable (CD-R/W), Digital Versatile Disc (DVD), BLU-RAY® Disc (BD), and semiconductor memories (such as mask ROM, programmable ROM (PROM), erasable PROM (EPROM), flash memory, random access memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different from those which are disclosed. Therefore, although the invention has been described based on these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

We claim:

1. A computer-implemented method, comprising:
accessing, by a server system, historical transaction data from a database associated with the server system, the historical transaction data comprising entity-specific data, cardholder-specific data, and transaction-specific data;
generating, by the server system, one or more pseudo-objective models for each of a plurality of entities based, at least in part, on the historical transaction data and one or more pseudo-objectives, the plurality of entities comprising an acquirer, a merchant, and an issuer;
determining, by the server system via the one or more pseudo-objective models, entity-specific embeddings for each entity of the plurality of entities based, at least in part, on the entity-specific data, the entity-specific embeddings comprising acquirer-specific embeddings, merchant-specific embeddings, and issuer-specific embeddings;
upon receiving a request to induct a new entity, accessing, by the server system, new entity data associated with the new entity from the database, the new entity data comprising transaction data associated with the new entity;
determining, by the server system, approximate embeddings corresponding to the new entity based, at least in part, on the new entity data and the entity-specific embeddings; and
updating, by the server system, one of the entity-specific embeddings based, at least in part, on the approximate embeddings.

2. The computer-implemented method as claimed in claim 1, wherein generating the one or more pseudo-objective models for each of the plurality of entities, further comprises:
determining, by the server system, an entity category of each of the plurality of entities based, at least in part, on the historical transaction data;
determining, by the server system, a desired model type for each of the one or more pseudo-objective models based, at least in part, on the entity category and each of the one or more pseudo-objectives; and
generating, by the server system, the one or more pseudo-objective models for each of the plurality of entities based, at least in part, on the desired model type and the historical transaction data.

3. The computer-implemented method as claimed in claim 1, wherein determining the approximate embeddings corresponding to the new entity, further comprises:
determining, by the server system, a new entity category of the new entity based, at least in part, on the new entity data, the new entity category being one of a new acquirer, a new merchant, and a new issuer;
determining, by the server system, a geo-location of the new entity based, at least in part, on the new entity data;
determining, by the server system, one or more neighboring entities with an identical entity category to the new entity category from the plurality of entities based, at least in part, on the transaction-specific data;
extracting, by the server system, one or more entity-specific embeddings associated with the one or more neighboring entities from the entity-specific embeddings of each of the plurality of entities; and
computing, by the server system, an average of the one or more entity-specific embeddings associated with the one or more neighboring entities to determine the approximate embeddings corresponding to the new entity.

4. The computer-implemented method as claimed in claim 1, further comprising:
generating, by the server system via a dynamic entity model, dynamic embeddings corresponding to each of a plurality of transactions based, at least in part, on the acquirer-specific embeddings, the merchant-specific embeddings, and the transaction-specific data;
generating, by the server system, aggregated dynamic embeddings corresponding to a plurality of transactions based, at least in part, on aggregating each of the dynamic embeddings corresponding to each of the plurality of transactions;
generating, by the server system via a static entity model, static embeddings based, at least in part, on the issuer-specific embeddings and the cardholder-specific data; and
generating, by the server system, a task-specific model based, at least in part, on the aggregated dynamic embeddings and the static embeddings.

5. The computer-implemented method as claimed in claim 4, wherein aggregating each of the dynamic embeddings corresponding to each of a plurality of transactions is performed via at least one of a recurrent neural network (RNN) and a long short-term memory network (LSTM) model.

6. The computer-implemented method as claimed in claim 4, wherein aggregating each of the dynamic embeddings corresponding to each of a plurality of transactions is performed via a geometric decay network.

7. The computer-implemented method as claimed in claim 6, wherein aggregating each of the dynamic embeddings corresponding to each of a plurality of transactions, further comprises:
computing, by the server system via the geometric decay network, a weighted sum of the dynamic embeddings corresponding to each of the plurality of transactions to generate the aggregated dynamic embeddings based, at least in part, on a geometric decay factor.

8. The computer-implemented method as claimed in claim 1, further comprising:
determining, by the server system, the one or more pseudo-objectives for a task to be performed by the one or more pseudo-objective models based, at least in part, on a set of predefined rules.

9. The computer-implemented method as claimed in claim 1, wherein the dynamic entity model and the static entity model are recurrent neural network (RNN).

10. The computer-implemented method as claimed in claim 1, wherein the server system is a payment server associated with a payment network.

11. A server system, comprising:
a memory configured to store instructions;
a communication interface; and
a processor in communication with the memory and the communication interface, the processor configured to execute the instructions stored in the memory and thereby cause the server system to perform, at least in part, to:
access historical transaction data from a database associated with the server system, the historical transaction data comprising entity-specific data, cardholder-specific data, and transaction-specific data;
generate one or more pseudo-objective models for each of a plurality of entities based, at least in part, on the historical transaction data and one or more pseudo-objectives, the plurality of entities comprising an acquirer, a merchant, and an issuer;
determine via the one or more pseudo-objective models, entity-specific embeddings for each entity of the plurality of entities based, at least in part, on the entity-specific data, the entity-specific embeddings comprising acquirer-specific embeddings, merchant-specific embeddings, and issuer-specific embeddings;
upon receiving a request to induct a new entity, access new entity data associated with the new entity from the database, the new entity data comprising transaction data associated with the new entity;
determine approximate embeddings corresponding to the new entity based, at least in part, on the new entity data and the entity-specific embeddings; and
update one of the entity-specific embeddings based, at least in part, on the approximate embeddings.

12. The server system as claimed in claim 11, wherein to generate the one or more pseudo-objective models for each of the plurality of entities, the server system is further caused, at least in part, to:
determine an entity category of each of the plurality of entities based, at least in part, on the historical transaction data;
determine a desired model type for each of the one or more pseudo-objective models based, at least in part, on the entity category and each of the one or more pseudo-objectives; and
generate the one or more pseudo-objective models for each of the plurality of entities based, at least in part, on the desired model type and the historical transaction data.

13. The server system as claimed in claim 11, wherein to determine the approximate embeddings corresponding to the new entity, the server system is further caused, at least in part, to:
determine a new entity category of the new entity based, at least in part, on the new entity data, the new entity category being one of a new acquirer, a new merchant, and a new issuer;
determine a geo-location of the new entity based, at least in part, on the new entity data;
determine one or more neighboring entities with an identical entity category to the new entity category from the plurality of entities based, at least in part, on the transaction-specific data;
extract one or more entity-specific embeddings associated with the one or more neighboring entities from the entity-specific embeddings of each of the plurality of entities; and
compute an average of the one or more entity-specific embeddings associated with the one or more neighboring entities to determine the approximate embeddings corresponding to the new entity.

14. The server system as claimed in claim 11, wherein the server system is further caused, at least in part, to:
generate via a dynamic entity model, dynamic embeddings corresponding to each of a plurality of transactions based, at least in part, on the acquirer-specific embeddings, the merchant-specific embeddings, and the transaction-specific data;
generate aggregated dynamic embeddings corresponding to a plurality of transactions based, at least in part, on aggregating each of the dynamic embeddings corresponding to each of the plurality of transactions;
generate via a static entity model, static embeddings based, at least in part, on the issuer-specific embeddings and the cardholder-specific data; and
generate a task-specific model based, at least in part, on the aggregated dynamic embeddings and the static embeddings.

15. The server system as claimed in claim 14, wherein aggregating each of the dynamic embeddings corresponding to each of a plurality of transactions is performed via at least one of a recurrent neural network (RNN) and a long short-term memory network (LSTM) model.

16. The server system as claimed in claim 14, wherein aggregating each of the dynamic embeddings corresponding to each of a plurality of transactions is performed via a geometric decay network.

17. The server system as claimed in claim 16, wherein to aggregate each of the dynamic embeddings corresponding to each of a plurality of transactions, the server system is further caused, at least in part, to:
compute via the geometric decay network, a weighted sum of the dynamic embeddings corresponding to each of the plurality of transactions to generate the aggregated dynamic embeddings based, at least in part, on a geometric decay factor.

18. A non-transitory computer-readable storage medium comprising computer-executable instructions that, when executed by at least a processor of a server system, cause the server system to perform a method comprising:
accessing historical transaction data from a database associated with the server system, the historical transaction data comprising entity-specific data, cardholder-specific data, and transaction-specific data;
generating one or more pseudo-objective models for each of a plurality of entities based, at least in part, on the historical transaction data and one or more pseudo-objectives, the plurality of entities comprising an acquirer, a merchant, and an issuer;
determining via the one or more pseudo-objective models, entity-specific embeddings for each entity of the plurality of entities based, at least in part, on the entity-specific data, the entity-specific embeddings comprising acquirer-specific embeddings, merchant-specific embeddings, and issuer-specific embeddings;
upon receiving a request to induct a new entity, accessing new entity data associated with the new entity from the database, the new entity data comprising transaction data associated with the new entity;
determining approximate embeddings corresponding to the new entity based, at least in part, on the new entity data and the entity-specific embeddings; and
updating one of the entity-specific embeddings based, at least in part, on the approximate embeddings.

19. The non-transitory computer-readable storage medium as claimed in claim 18, wherein for generating the one or more pseudo-objective models for each of the plurality of entities, the method further comprises:
determining an entity category of each of the plurality of entities based, at least in part, on the historical transaction data;
determining a desired model type for each of the one or more pseudo-objective models based, at least in part, on the entity category and each of the one or more pseudo-objectives; and
generating the one or more pseudo-objective models for each of the plurality of entities based, at least in part, on the desired model type and the historical transaction data.

20. The non-transitory computer-readable storage medium as claimed in claim 19, wherein for determining the approximate embeddings corresponding to the new entity, the method further comprises:
determining a new entity category of the new entity based, at least in part, on the new entity data, the new entity category being one of a new acquirer, a new merchant, and a new issuer;
determining a geo-location of the new entity based, at least in part, on the new entity data;
determining one or more neighboring entities with an identical entity category to the new entity category from the plurality of entities based, at least in part, on the transaction-specific data;
extracting one or more entity-specific embeddings associated with the one or more neighboring entities from the entity-specific embeddings of each of the plurality of entities; and
computing an average of the one or more entity-specific embeddings associated with the one or more neighboring entities to determine the approximate embeddings corresponding to the new entity.
